(19) United States
(12) Patent Application Publication
(10) Pub. No.: US 2008/0244639 A1
(43) Pub. Date: Oct. 2, 2008

(54) Providing advertising

(76) Inventor: Kimberly J. Kaaz, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/731,575

(22) Filed: Mar. 29, 2007

(51) Int. Cl. H04N 5/445

(52) U.S. Cl. 725/34

(57) ABSTRACT

A system for providing advertising includes an electronic video display for displaying advertising disposed in an advertising venue; and a sensor for sensing a number of people in an audience of the electronic video display. A method of providing advertising includes providing an electronic video display at an advertising venue; and providing a sensor with the electronic video display configured to determine a number of people in an audience of the electronic video display.

### BACKGROUND

Advertisers are constantly looking for opportunities to present information about their products to customers and potential customers. For example, advertising is provided on television, in magazines and newspapers, on web-sites, on roadside billboards, at sporting and other events, by mail, on moving vehicles, etc.

Typically, the wider an audience that a given advertising medium is expected to reach, the more it will cost the advertiser to place advertising in that medium. For example, on television, surveys are conducted to determine the number of viewers any particular television show attracts. Advertisers are then charged to have their advertising and commercials shown in connection with that television program based on that assessment of audience size. The larger the audience, the more expensive it will be to advertise during, or as a sponsor of, that television program.

Similarly, on the Internet, advertisers may be charged based on the traffic a host can generate to the advertiser's materials. For example, the advertiser may be charged based on the number of hits to a host web-site where advertising is posted. Alternatively, the advertiser may be charged based on the number of times a browser links to the advertiser's materials from a host web page.

Clearly, the more viewers an advertising medium can obtain, the greater the value to an advertiser of placing advertising in that medium. Consequently, the advertiser will be willing to pay, and will likely be charged, based on the popularity of the advertising medium in question.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 illustrates an exemplary system according to principles described herein for providing advertising to an audience.

FIG. 2 further illustrates the exemplary system of FIG. 1 for providing advertising to an audience based on a detected size of the audience according to principles described herein.

FIG. 3 is a flowchart illustrating an exemplary method of providing advertising to an audience based on a detected size of the audience according to principles described herein.

FIG. 4 is a flowchart illustrating another exemplary method of providing advertising to an audience based bidding by advertisers given a detected size of the actual audience according to principles described herein.

Throughout the drawings, identical reference numbers designate similar, but not necessarily identical, elements.

### DETAILED DESCRIPTION

Electronic video displays for providing advertising are placed in a wide variety of venues. For example, such displays are commonly found in airports, shopping malls, train and bus stations, at sporting events, in movie theaters, in convention halls, in hotels, as roadside signs, on buildings, in waiting rooms, etc. Electronic video displays showing advertising are also found in airplanes, on trains and subways and other transit systems. As used herein and in the appended claims, the term “advertising venue” will refer to these and any other location where an electronic video display for advertising may be placed.

Any of a wide variety of devices can be used as the electronic video display for displaying advertising described herein. For example, large and small scale liquid crystal displays are frequently used as electronic video displays for displaying advertising. However, an electronic video display may also be a cathode ray tube (CRT) display, a light-emitting diode (LED) display, a plasma screen device or any other television, monitor or display device on which advertising can be displayed. As used herein and in the appended claims, the term “electronic video display” will refer to these and any other devices for visually displaying advertising or advertising materials to an audience, with or without accompanying audio.

As used herein and in the appended claims, the term “advertising,” “advertisement” or “advertising materials” will be used broadly to describe any visual content, whether motion picture video, a still image or a series of still images, with or without accompanying audio, that is displayed to promote sales of goods or services or to influence purchases or opinions on behalf of an advertiser.

As noted above, many types of advertising media have developed a mechanism for assessing how effecting that particular advertising medium is. This is typically measured by determining the number of people, customers or potential customers, who are exposed to the advertising presented in that medium. As also noted above, the wider the audience an advertising medium can attract and document, the more that advertising medium can charge for its services.

The present specification describes a system and method for determining the number of people present at an electronic video display on which advertising can be presented. Consequently, advertising can be generated and sold using that electronic video display based on that number of people composing the actual and immediately-available audience for the advertising.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

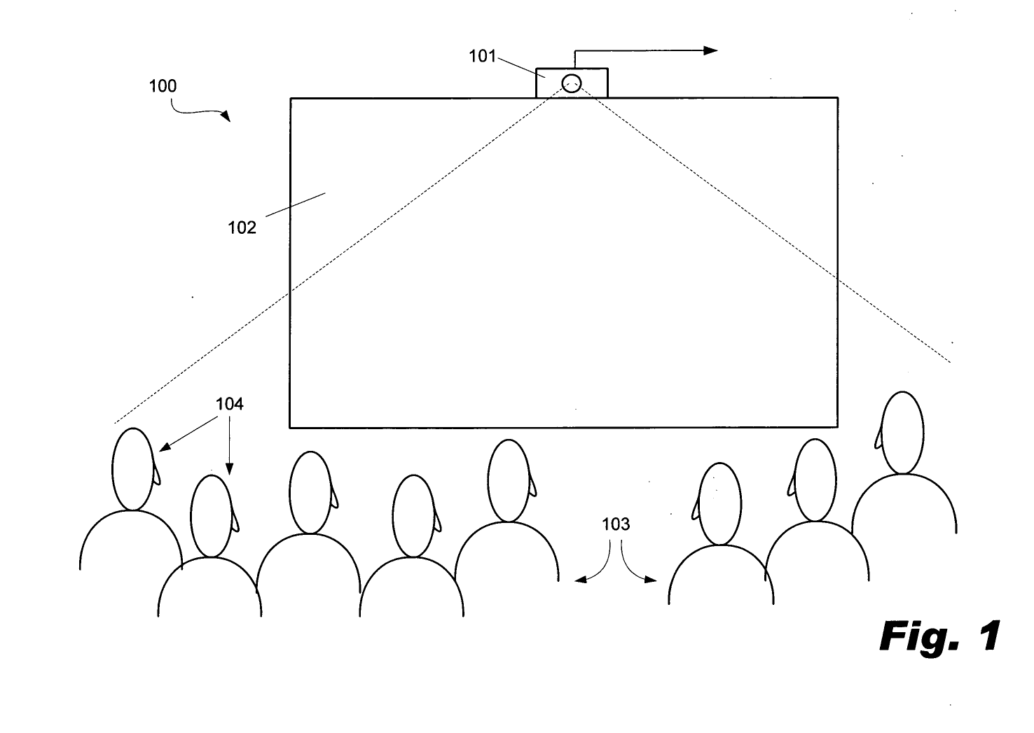

FIG. 1 illustrates an exemplary system (100) according to principles described herein for providing advertising to an audience. As shown in FIG. 1, an electronic video display (102) is provided at or in an advertising venue. As noted above, the advertising venue can be any location where people might be and can be exposed to advertising. For example, the advertising venue may be an airport, a train or bus station, a shopping mall, a waiting room, a sporting event, a convention or meeting hall, a hotel, a sporting or other event or a roadside sign.

The electronic video display (102) may be, for example, any display device capable of displaying advertising or advertising materials, with or without accompanying audio. In some examples, the electronic video display (102) is a large-scale liquid crystal display device or monitor.

As shown in FIG. 1, an audience (103) of people will tend to view the electronic video display (102). In some examples, the number of people in the audience (103) may be in constant fluctuation as people come and go from the advertising venue. In other examples, the number of people in the audience (103) may be fairly constant for a period of time depending on the nature of the advertising venue.

As also shown in FIG. 1, the electronic video display (102) includes a sensor (101). The sensor (101) may be any sensor that helps determine the size of the audience (103) at the electronic video display (102). For example, the sensor (101) may be an infrared sensor that counts the audience based on body heat patterns. Alternatively, the sensor (101) may be an optical camera for imaging the audience.

The sensor (101) is aimed so as to capture an image of the audience (103) of the electronic video display (102). Consequently, the sensor (101) may be aimed and configured to image that area in which the audience (103) is likely to congregate and from which the audience (103) will be able to view the electronic video display (102).

In the example illustrated in FIG. 1, the sensor (101) is an optical camera, for example, a charge coupled device (CCD). Depending on the size of the audience area, the camera (101) may be a wide angle camera. In other examples, the camera (101) may be in motion, panning over the area where the audience (103) is likely to congregate, so as to cover a wider audience area. In still other examples, the camera (101) may be embodied as a number of cameras aimed at different portions of an audience area so as to adequately monitor the entire audience area.

As will be explained in more detail below, the image from the camera or other sensor (101) can be used to identify the number of people in the audience (103). IN the case of an optical camera, this may be done based on facial recognition. Specifically, each person in the audience (103) has a face (104). While distinguishing electronically between two different human faces is a non-trivial task to which a great amount of work has been dedicated, for advertising purposes, it is only necessary to distinguish a face (104) from other objects in the image taken by the camera (101). Once a number of faces are identified from the image taken by the camera (101), the number of people in the audience (103) can be determined with a sufficient degree of accuracy to assess the value of the audience (103) to an advertiser who is, or is considering, placing advertising on the electronic video display (102).

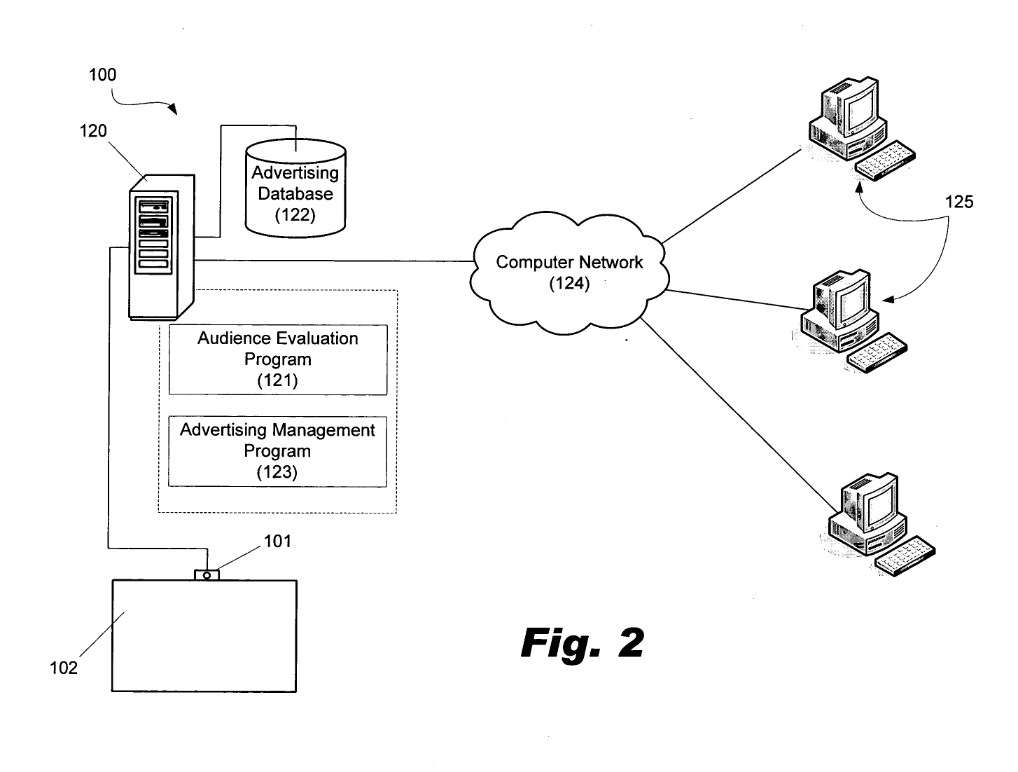

FIG. 2 further illustrates the exemplary system (100) of FIG. 1 for providing advertising to an audience based on a detected size of the audience according to principles described herein. As shown in FIG. 2, the image from the sensor, e.g., a camera or camera array, (101) is output to a server (120). The sensor (101) may communicate with the server (120) by a wired or wireless connection.

The server (120) includes an audience evaluation program (121) that is executed by the server (120). The audience evaluation program (121) takes as input the signal from the sensor (101) and produces as output a determination of the number of people in the audience (103, FIG. 1). As indicated above, the audience evaluation program (121) may process an image signal from an optical camera (101) and identify within the image or images received the instance of each human face in the audience. This can be done based on feature recognition of the basic features of a human face without the need for the resolution that would distinguish one human face from another. See, for example, U.S. Pat. Nos. 7,099,510; 6,556,989; 5,966,696; 5,923,252; 5,642,484 and 6,958,710; and U.S. Patent App. Pub. Nos. 2002-0077891, 2005-0198661 and 2006-0287913, all of which are incorporated by reference herein in their respective entireties.

The determination of the size of the audience is provided by the audience evaluation program (121) to an advertising management program (123). As will be described in more detail below, the advertising management program (123) uses the determination generated as to the size of the audience at the electronic video display (102) to sell advertising time on the electronic video display (102) to advertisers or to determine when to display particular advertising on the electronic video display (102).

The server (120) may also be connected to an advertising database (122). This database (122) may be contained within the server (120) or may be a separate device, such as a server or disc array, that provides additional data storage for the server (120).

Advertisers who wish to purchase time on the electronic video display (102) for their advertising can submit the advertising to the system (100) for later display on the electronic video display (102). The advertising is stored electronically, until needed, in the advertising database (122).

The advertising management program (123) will access particular advertising materials stored in the database (122), under appropriate circumstances as described below, and output that advertising to the electronic video display (102). The server (120) or advertising management program (123) will convert the stored electronic data of the advertising in the database (122) to a video or audio/video signal that is output to the electronic video display (102). The desired advertising is then shown on the electronic video display (102) to the audience (103, FIG. 1).

In some embodiments, the server (120) is also connected to a computer network (124). This computer network (124) may be a global computer network, such as the Internet, or may be a local or wide area network belonging to the electronic video display (102) operator.

A number of advertising customers or advertisers, represented by the illustrated workstations (125), may also have access to the network (124) and use the network (124) to communicate with the server (120). For example, the advertisers (125) may transmit electronic advertising materials via the network (124) to the server (120). As described above, the server (120) may cache the electronic advertising materials in the advertising database (122) until conditions are appropriate for displaying that advertising on the electronic video display (102).

The advertisers (125) may also use the network (124) to submit advertising orders, contracts or bids to the advertising management program (123) on the server (120). Additionally, the advertising management program (123) may use the network (124) to inform the advertisers (125) of the size of the audience (103, FIG. 1) that has been measured at the electronic video display (102). This may be a dynamic number reflecting the current audience size or may be a compilation of data prepared by the advertising management program that tracks the size of the audience over some specified period of time in the past. In this way, the advertisers (125) can make informed decisions about whether and when to place advertising on the electronic video display (102).

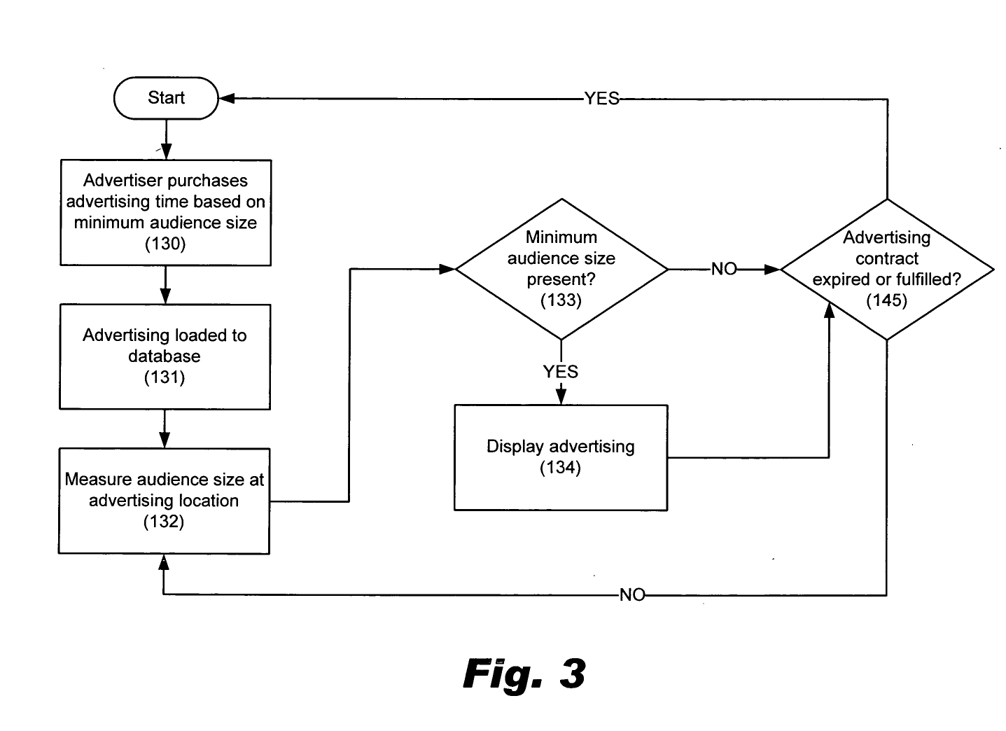

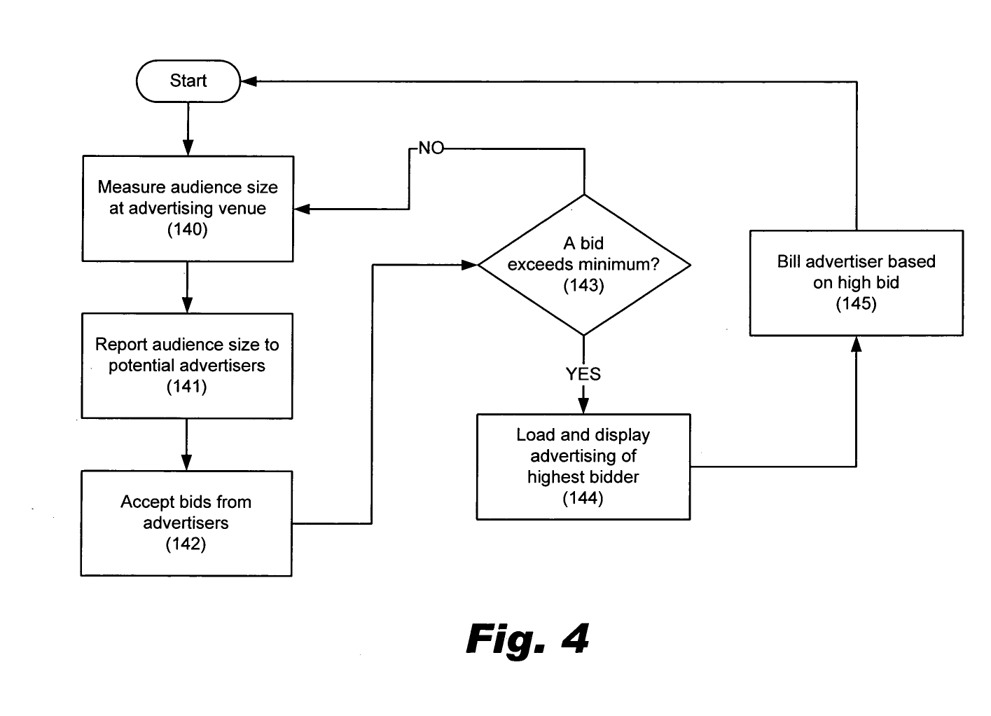

As will be appreciated by those skilled in the art, there are a great many methods and ways in which the system described in connection with FIGS. 1 and 2 could be used to provide advertising to an audience and to sell such advertising opportunities to advertisers. All such methods and uses are within the scope of the present specification. Two such possible implementations of the system of FIGS. 1 and 2 will now be described by way of example using FIGS. 3 and 4.

FIG. 3 is a flowchart illustrating an exemplary method of providing advertising to an audience based on a detected size of the audience according to principles described herein. As shown in FIG. 3, the method begins when an advertiser decides to purchase advertising time on the electronic video display (step 130).

The advertiser can purchase time on the electronic video display based on a number of parameters. For example, the advertiser may specify that the advertising is to be displayed a certain number of times, perhaps within a given period of time. The advertiser may also specify that the advertising is only to be shown on the electronic video display when the audience at the electronic video display, as determined by a system such as that described above, equals or exceeds a minimum threshold.

Referring to the system of FIG. 2, an advertiser (125) may contact the advertising management program (123) on the server (120) via the network (124) in order to create the advertising contract (step 130). For example, the advertising management program (123) may receive from an advertiser (125) the information specifying the minimum audience threshold that is to trigger display of the advertiser's advertising materials and any limits on the number of times or the time period during which the advertising is to be shown. The advertising management program (123) may also advise the advertiser (125) what the charge will be for displaying the advertising. The charge may be based, for example, on each time the advertising is displayed or some other parameter.

Referring again to FIG. 3, once the details of the advertising contract have been established, the advertising materials are loaded to the system (step 131). This may be done, for example, by receiving the desired advertising materials from the purchasing advertiser via the network (124, FIG. 2) and storing the data for the advertising materials in the advertising database (122, FIG. 2).

Next, the system will monitor the size of the audience at the electronic video display (102, FIG. 2) as described above (step 132). The advertising management program (123, FIG. 2) will compare the measured size of the audience with the minimum threshold specified by the advertiser. If the size of the audience meets or exceeds that threshold (determination 133), the advertising management program (123, FIG. 2) will retrieve the advertiser's advertising materials from the database (122, FIG. 2) and display the advertising (step 134) on the electronic video display (102, FIG. 2).

This process will continue until the contract with the advertiser has been completed (determination 145). For example, if the advertiser has specified that the advertising be shown a specific number of times to an audience at or above the minimum threshold size, when the advertising has been so displayed that specific number of times, the advertising contract is completed (determination 145). The advertiser may then be billed for the advertising provided.

In another example, the advertiser may have specified a period of time, such as an hour, a day, a week, a month, etc., during which the advertising is to be displayed when the audience present meets or exceeds the specified minimum threshold (determination 133). Where this is the case, the system will display the advertising (step 134) each time the minimum audience size is met or exceeded (determination 133). Then, upon expiration of the time period specified by the advertiser, the advertising contract is complete (determination 145) and the system stops displaying that advertising.

The advertiser may be billed based on the number of times during the specified time period that the minimum required audience was assembled and the advertising displayed. This billing may be on a periodic or per contract basis.

In any example, the advertising management program (123, FIG. 2) may automatically bill the advertiser, for example, by charging a credit card or debit account, for the advertising provided based on the terms of the contract made with that advertiser. In other embodiments, the advertising management program (123, FIG. 2) may generate an invoice for the advertiser. As noted, the billing, whether automatic or by invoice, may be completed on a periodic basis or upon completion of the advertising contract.

FIG. 4 is a flowchart illustrating another exemplary method of providing advertising to an audience based bidding by advertisers given a detected size of the actual audience according to principles described herein. The example of FIG. 4 may be particularly well-suited to examples in which the audience for the electronic video display (102, FIG. 2) is relatively static, such as people attending a movie or sporting event or in a waiting area, who are in place at the electronic video display for an extended period of time. Although, this is not necessarily so.

As shown in FIG. 4, the system described by way of example herein again measures the size of the audience at the electronic video display in the advertising venue (step 140). The size of the audience is then reported dynamically or periodically to a number of registered advertisers or potential advertisers.

Referring to FIG. 2, again, the advertising management program (123) uses the network (124) to report to a population of advertisers (125) the size of the audience currently acquired at the electronic video display (102). Using the network (124), the advertisers (125) can respond dynamically, as explained below, to the measured size of the audience at the electronic video display (102).

Returning to FIG. 4, the advertisers may submit bids for displaying their advertising to the audience at the electronic video display (102, FIG. 2) based on the measured and reported size of that audience. The advertising management program (123, FIG. 2) will receive and evaluate those bids (step 142).

In some examples, the operator of the system (100, FIG. 2) may establish a minimum threshold that an advertiser must pay to have advertising displayed on the electronic video display. This minimum threshold may fluctuate depending on prevailing circumstances such as time of day or conditions at the electronic video display. For example, the minimum threshold charge for displaying advertising on the electronic video display may increase during a lunch hour or commuter rush hour and decrease during early morning and other low traffic hours. In another example, if a special event is being held at or in the vicinity of the electronic video display, the minimum threshold charge for displaying advertising may increase.

Where some minimum threshold charge for advertising has been established, the method next determines whether any of the bids received meet or exceed the specified minimum acceptable bid (determination 143). If no bid satisfies the specified minimum, the system may continue reporting audience size information to potential advertisers (step 140) until a satisfactory bid is received.

When a bid is received that satisfies the established minimum (determination 143), the advertising for that advertiser is loaded and displayed (step 144). If multiple bids are received that satisfy the established minimum (determination 143), the advertising of the highest bidder may be loaded and displayed. In some examples, only the advertising of the highest bidder is displayed. In other examples, the advertising of lower bidders may be loaded and displayed sequentially in the order of the bid amounts.

Referring to FIG. 2, loading and displaying advertising for the winning bidder or bidders may be done by accessing the electronic advertising materials of the winning bidder in the advertising database (122). The electronic advertising materials are then formatted as a video or audio/video signal and output to the electronic video display (102). The advertisers (125) may have loaded their advertising materials electronically to the database (122) prior to placing any bids. In this way, as soon as such an advertiser submits a winning bid to have advertising displayed, the desired advertising is immediately available for display having already been loaded to the database (122) of the system (100).

Returning to FIG. 4, after the advertising has been shown (step 144), the corresponding advertiser is billed (step 145) based on the winning bid submitted by that advertiser. As noted above, the advertising management program (123, FIG. 2) may automatically bill the advertiser or generate an invoice for the advertiser.

The method illustrated in FIG. 4 can then repeat as long as there is an audience at the electronic video display and advertisers are submitting bids for advertising time.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A system for providing advertising, said system comprising:
an electronic video display for displaying advertising disposed in an advertising venue; and
a sensor for sensing a number of people in an audience of said electronic video display,
wherein said system selects what advertising to display on said electronic video display based on said number of people in said audience.

2. The system of claim 1, wherein said sensor comprises an optical camera.

3. The system of claim 2, further comprising an evaluation program configured to determine a number of human faces in an image output by said optical camera.

4. The system of claim 1, wherein said sensor comprises an infrared camera.

5. The system of claim 1, further comprising an advertising database storing advertising materials to be displayed on said electronic video display based on said number of people in said audience.

6. The system of claim 1, further comprising a server for managing advertising shown on said electronic video display based on said number of people in said audience.

7. The system of claim 6, wherein said server communicated electronically via a network with a plurality of advertisers.

8. A method of providing advertising comprising:
providing an electronic video display at an advertising venue;
providing a sensor with said electronic video display configured to determine a number of people in an audience of said electronic video display; and
selecting advertising to display on said electronic video display based on said number of people in said audience.

9. The method of claim 8, wherein said sensor comprises an optical camera and said method further comprises determining a number of human faces in an image output by said optical camera.

10. The method of claim 8, wherein said sensor comprises an infrared camera and said method further comprises counting a number of human body heat patterns in said audience.

11. The method of claim 8, further comprising displaying advertising on said electronic video display based on said number of people in said audience.

12. The method of claim 8, further comprising assembling an advertising database storing advertising materials to be displayed on said electronic video display based on said number of people in said audience.

13. The method of claim 8, further comprising displaying advertising on said electronic video display only when said number of people in said audience meets or exceeds a minimum threshold.

14. The method of claim 13, further comprising allowing an advertiser corresponding to said advertising to specify said minimum threshold.

15. The method of claim 8, further comprising dynamically reporting said number of people in said audience to a population of advertisers.

16. The method of claim 15, further comprising accepting bids from said population of advertisers for displaying advertising on said electronic video display.

17. The method of claim 16, further comprising comparing said bids to a minimum acceptable bid amount.

18. The method of claim 17, further comprising varying said minimum acceptable bid amount based on conditions at said electronic video display.

19. The method of claim 16, further comprising displaying advertising on said electronic video display corresponding to an advertiser from said population that submits a highest bid.

20. A system of providing advertising comprising:
an electronic video display at an advertising venue;
means for determining a number of people in an audience of said electronic video display; and
means for selling advertising time on said electronic video display based on said number of people determined to be present at said electronic video display.
